(19) United States
(12) Patent Application Publication
(10) Pub. No.: US 2020/0388797 A1
(43) Pub. Date: Dec. 10, 2020

(54) FLAME-RETARDANT MATERIAL

(71) Applicant: Cheng Uei Precision Industry Co., Ltd., New Taipei City (TW)

(72) Inventor: JEN-KAI HUANG, New Taipei City (TW)

(21) Appl. No.: 16/679,282

(22) Filed: Nov. 10, 2019

(30) Foreign Application Priority Data
Jun. 6, 2019 (CN) 201910489856.2

(51) Int. Cl. H01M 2/02; B32B 9/04; B32B 7/12

(52) U.S. Cl. CPC H01M 2/029; B32B 7/12; H01M 2/0295; B32B 9/04

(57) ABSTRACT

A flame-retardant material, made up of a mixture of a first carrier, a macromolecule material, a first additive and a second additive, wherein the first carrier is a soft material, the macromolecule material is disposed in the first carrier, the macromolecule material is a composite material composed of nano silica and nano clay, the first additive is disposed in the first carrier, the first additive is aluminum hydroxide (Al(OH)₃.nH₂O), the second additive is disposed in the first carrier, the second additive is magnesium hydroxide (Mg(OH)₂.nH₂O). As above, the flame-retardant material is made up of the mixture of the first carrier, the macromolecule material, the first additive and the second additive, thereby having uniform heat transfer and dissipation which provide favourable effect on avoiding flame propagation and explosion.

### BACKGROUND OF THE INVENTION

### 1. Field of the Invention

The present invention is submitted based on application no. 201910489856.2 of Jun. 6, 2019 as priority in China, incorporated herein by reference in its entirety. The present invention generally relates to a flame-retardant material, and more particularly to a flame-retardant material with uniform heat transfer and dissipation, capable of avoiding flame propagation and explosion.

### 2. Related Art

In energy-dense lithium-ion battery cell module system, battery cells easily become unstable and lead to explosion under the influence of heat, shock, collision, etc. Because of closer stacking of the battery cells, as soon as one of the battery cells appears thermal runaway, the whole battery cell module would be readily burned and generate a heat that causes uncontrollable chain reactions or even an explosion, which leads to an unexpected result and a loss of the whole battery cell module.

Therefore, there is a need to provide a flame-retardant material capable of avoiding flame propagation and preventing the battery cells from thermal runaway for insuring security of the battery cell module.

### SUMMARY OF THE INVENTION

An object of the present invention is to provide a flame-retardant with uniform heat transfer and dissipation which has favourable effect on avoiding flame propagation and explosion.

To attain this, A flame-retardant material, made up of a mixture of a first carrier, a macromolecule material, a first additive and a second additive, wherein the first carrier is a soft material, the macromolecule material is disposed in the first carrier, the macromolecule material is a composite material composed of nano silica and nano clay, the first additive is disposed in the first carrier, the first additive is aluminum hydroxide (Al(OH)₃.nH₂O), the second additive is disposed in the first carrier, the second additive is magnesium hydroxide (Mg(OH)₂.nH₂O).

Accordingly, the first carrier is made of silicon that is present in a form of gel.

Accordingly, the silicon is present in an amount of 30-50 wt %.

Accordingly, the silicon does not include any bridging agent, and remains a pure mixture.

Accordingly, the composite material composed of the nano silica and the nano clay is present in an amount of 3-10 wt %.

Accordingly, the aluminum hydroxide is present in an amount of 40-60 wt %.

Accordingly, the magnesium hydroxide is present in an amount of 5-40 wt %.

Accordingly, a side of the first carrier is pasted with a second carrier, and the second carrier is a tape.

As above, the flame-retardant material is made up of the mixture of the first carrier, the macromolecule material, the first additive and the second additive, thereby having uniform heat transfer and dissipation which provide favourable effect on avoiding flame propagation and explosion.

### BRIEF DESCRIPTION OF THE DRAWINGS

FIG. 1 is a schematic view showing components of a flame-retardant material in accordance with the present invention;

FIG. 2 is a perspective view showing the flame-retardant material in accordance with the present invention configured on a battery cell; and

FIG. 3 is a schematic view of the flame-retardant material according to another embodiment of the present invention.

### DESCRIPTION OF THE PREFERRED EMBODIMENTS

In order to describe the technical contents, structural features, purpose to be achieved and the effectiveness of the present invention, the detailed description is given with schema below.

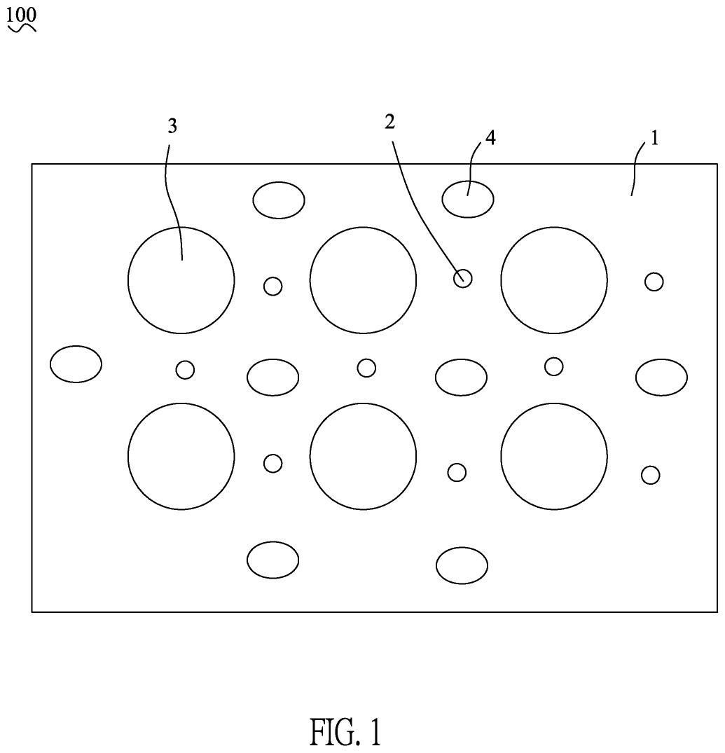

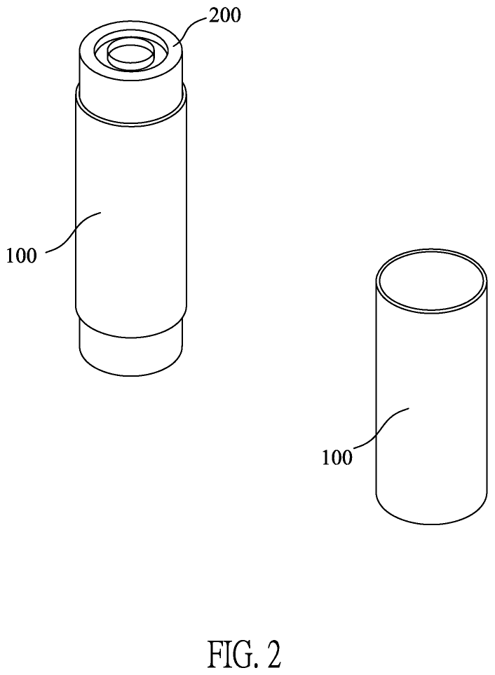

Referring to FIG. 1 and FIG. 2, in an embodiment of the present invention, a flame-retardant material 100 is covered at an external surface of a battery cell 200, but is not limited thereto. The flame-retardant material 100 can be applied in buildings or fabric. The flame-retardant material 100 is made up of a mixture of a first carrier 1, a macromolecule material 2, a first additive 3 and a second additive 4.

The first carrier 1 covers the macromolecule material 2, the first additive 3 and the second additive 4. The first carrier 1 is a soft material. More specifically, the first carrier 1 is made of silicon that is present in a form of gel with an amount of 30-50 wt %. Said silicon does not include any bridging agent and thus induces no crosslinking reaction, so the silicon is self-adhesive and is able to be pasted on the battery cell 200. Furthermore, because no chemical reaction occurs such as the crosslinking reaction, the silicon remains a pure mixture. As long as there is no functional damage, the silicon can be produced ceaselessly and is recyclable for reuse.

The macromolecule material 2 is disposed in the first carrier 1. The macromolecule material 2 has a thermal resistance property and involves thermal conducting materials. In this embodiment, the macromolecule material 2 is solid. The macromolecule material 2 is a composite material composed of nano silica (SiO2) and nano clay. More specifically, the composite material composed of the nano silica and the nano clay is present in an amount of 3-10 wt %. When heated, the composite material gathers at an end in contact with a flame to form a block layer consisted of the nano silica and the nano clay for blocking the flame.

The first additive 3 is disposed in the first carrier 1. The first additive 3 is aluminum hydroxide (Al(OH)₃.nH₂O). The aluminum hydroxide is a solid material. More specifically, the aluminum hydroxide is present in an amount of 40-60 wt %. When heated to 130° C., the aluminum hydroxide decomposes into aluminum oxide (Al₂O₃) of less volume. Because of volume change, a phase change (from solid to gas) occurs, thereby forming voids in the flame-retardant material 100 to block the flame.

The second additive 4 is disposed in the first carrier 1. The second additive 4 is magnesium hydroxide (Mg(OH)₂.nH₂O). The magnesium hydroxide is solid. More specifically, the magnesium hydroxide is present in an amount of 5-40 wt %. When heated to 150° C., the magnesium hydroxide decomposes into magnesium oxide (MgO) of less volume. Because of volume change, a phase change (from solid to gas) occurs, thereby forming voids in the flame-retardant material 100 to block the flame as well.

Because the macromolecule material 2, the first additive 3 and the second additive 4 are solid, they are needed to be covered by the first carrier 1. After being processed by a processing equipment, the flame-retardant material 100 of the present invention is formed in a piece shape.

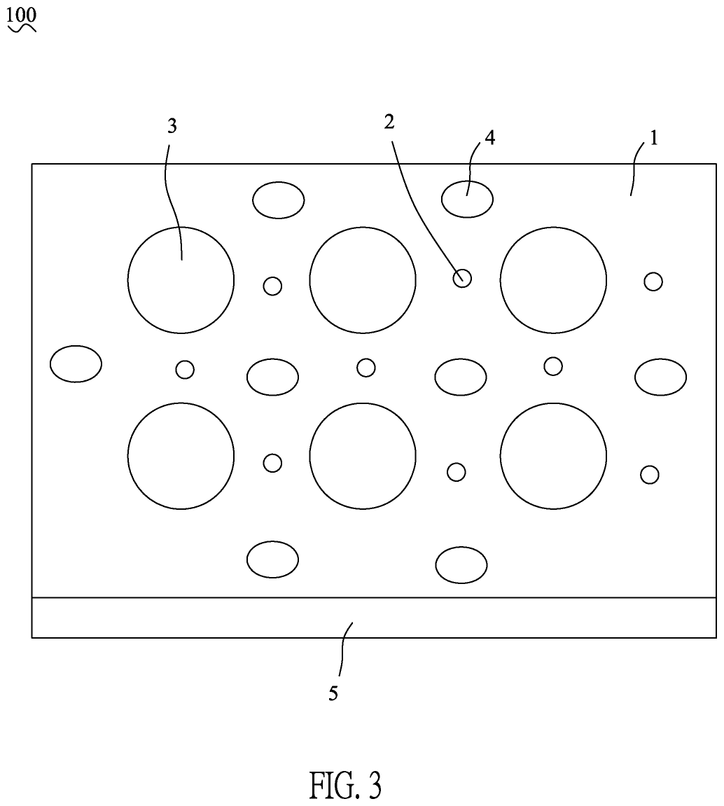

With reference to FIG. 3, a side of the first carrier 1 is pasted with a second carrier 5. The second carrier 5 is a tape. When the solid second carrier 5 is pasted on the side of the first carrier 1, a stiffness of the flame-retardant material 100 of the present invention is increased. Therefore, the flame-retardant material 100 can wrap the battery cell 200 or other products to facilitate processing operations.

Because the battery cell 200 easily becomes unstable and leads to explosion under the influence of heat, shock, collision, the flame-retardant material 100 of the present invention with uniform heat transfer and dissipation is provided to cover the outer side of the battery cell 200, capable of protecting the battery cell 200 from flame propagation and explosion. The material combination described in this embodiment has a thermal conductivity of 1.02 W/m ° C.

As above, the flame-retardant material 100 is made up of the mixture of the first carrier 1, the macromolecule material 2, the first additive 3 and the second additive 4, thereby having uniform heat transfer and dissipation which provide favourable effect on avoiding flame propagation and explosion.

What is claimed is:

1. A flame-retardant material, made up of a mixture of a first carrier, a macromolecule material, a first additive and a second additive, wherein the first carrier is a soft material, the macromolecule material is disposed in the first carrier, the macromolecule material is a composite material composed of nano silica and nano clay, the first additive is disposed in the first carrier, the first additive is aluminum hydroxide (Al(OH)₃.nH₂O), the second additive is disposed in the first carrier, the second additive is magnesium hydroxide (Mg(OH)₂.nH₂O).

2. The flame-retardant material of claim 1, wherein the first carrier is made of silicon that is present in a form of gel.

3. The flame-retardant material of claim 2, wherein the silicon is present in an amount of 30-50 wt %.

4. The flame-retardant material of claim 2, wherein the silicon does not include any bridging agent, and remains a pure mixture.

5. The flame-retardant material of claim 1, wherein the composite material composed of the nano silica and the nano clay is present in an amount of 3-10 wt %.

6. The flame-retardant material of claim 1, wherein the aluminum hydroxide is present in an amount of 40-60 wt %.

7. The flame-retardant material of claim 1, wherein the magnesium hydroxide is present in an amount of 5-40 wt %.

8. The flame-retardant material of claim 1, wherein a side of the first carrier is pasted with a second carrier, and the second carrier is a tape.
